(19) United States
(12) Patent Application Publication
(10) Pub. No.: US 2021/0378471 A1
(43) Pub. Date: Dec. 9, 2021

(54) VACUUM CLEANER

(71) Applicant: Aktiebolaget Electrolux, Stockholm (SE)

(72) Inventor: Roger Karlsson, Stockholm (SE)

(73) Assignee: Aktiebolaget Electrolux, Stockholm (SE)

(21) Appl. No.: 17/284,128

(22) PCT Filed: Oct. 12, 2018
(86) PCT No.: PCT/EP2018/077815

§ 371 Date: Apr. 9, 2021

(51) Int. Cl. A47L 9/28; A47L 5/36; A47L 5/28; A47L 9/00; A47L 9/32; A47L 9/24

(52) U.S. Cl. CPC A47L 9/2805; A47L 5/362; A47L 5/28; A47L 9/0072; A47L 9/248; A47L 9/327; A47L 9/2842; A47L 9/246; A47L 9/2857; A47L 9/325

(57) ABSTRACT

A vacuum cleaner comprising a fan driven by a motor, wherein the fan is configured to accomplish a suction flow from a vacuum cleaner nozzle via a hand-held tube having a direction of elongation, to a permeable dust collecting container. A sensing device is provided, sensing strain in the tube along its elongate direction, and a control arrangement controls the output of the motor in response to the sensed strain. This allows the vacuum cleaner to adapt to different floor surfaces.

### FIELD OF THE INVENTION

The present disclosure relates to a vacuum cleaner comprising a fan driven by a motor, the fan being configured to generate a suction flow from a vacuum cleaner nozzle via a tube, to a dust separation device, the vacuum cleaner comprising a handle. The present disclosure further relates to a method carried out in such a vacuum cleaner.

### TECHNICAL BACKGROUND

Such a vacuum cleaner is disclosed for instance in US-2018/0177368-A1. One technical problem associated with most vacuum cleaners is that to provide efficient cleaning a substantial suction force should be provided. This however may cause the vacuum cleaner's nozzle to become stuck, for instance when cleaning thick rugs, which disturbs operation of the vacuum cleaner.

### SUMMARY OF THE INVENTION

One object of the present disclosure is therefore to provide a vacuum cleaner that can run at high power while becoming stuck to a lesser extent. This object is achieved by means of a vacuum cleaner as defined in claim 1. More specifically, in a vacuum cleaner of the initially mentioned kind, a sensing device is provided, measuring a force along a direction between the handle and said nozzle. A control arrangement controls the output of the motor in response to the measured force. This arrangement allows the vacuum cleaner to temporarily lower the output in response to an increasing force applied between the nozzle and the handle, indicating that the nozzle is about to become stuck. This serves to avoid the nozzle becoming stuck, while maintaining an overall high power.

The sensing device may comprise a variable resistor. For instance, the variable resistor may be arranged at first and second parts, which are slidable in relation to each other in said direction against the force of a spring thereby changing the resistance of the variable resistor.

In another example, the sensing device may be a strain gauge load cell, which does not need moveable parts to provide an output. Such a load cell may be located in the aforementioned tube.

The control arrangement may be adapted to lower the motor output if the sensed force exceeds a predetermined threshold. As an example, the motor output may be lowered during a period of time.

Alternatively, the control arrangement may be configured to vary the motor output as a function of the sensed force.

The sensing device may be located in a vacuum cleaner tube, or in or close to the handle, e.g. in a bent end part.

The control arrangement may be affected by a user setting, e.g. the user setting may include turning an output-lowering function off, or may affect a threshold.

The vacuum cleaner may be of a type comprising a housing containing the motor, the fan and the dust separation device, wherein the housing is configured to be moveable on a floor, and a flexible tube connects the housing to one end of a rigid tube. This tube may have a handle part, and may comprise a nozzle arranged on the other end of the rigid tube.

Alternatively, the vacuum cleaner may be an upright- or stick-type vacuum cleaner.

Regardless of the vacuum cleaner type, the dust separation device may be a dust bag, a filter, a cyclone, or a combination thereof.

The present disclosure also relates to a method in a vacuum cleaner comprising a fan driven by a motor, the fan being configured to generate a suction flow from a vacuum cleaner nozzle via a tube, to a dust separation device, the vacuum cleaner comprising a handle. The method involves measuring a force along a direction between the handle and the nozzle, and controlling the output of the motor in response to the measured force. A force exceeding a predetermined threshold may trigger the lowering of the motor output during a predetermined time. This provides advantages corresponding to the vacuum cleaner as described above.

### BRIEF DESCRIPTION OF THE DRAWINGS

FIG. 1 illustrates an example of a vacuum cleaner.

FIG. 2 shows a block diagram of a control function according to the present disclosure.

FIGS. 3a and 3b illustrate schematically a first example of a strain sensing arrangement.

FIG. 4 illustrates a second example of a strain sensing arrangement.

FIG. 5 illustrates a basic method for a control arrangement.

FIG. 6 illustrates an upright- or stick-type vacuum cleaner.

### DETAILED DESCRIPTION

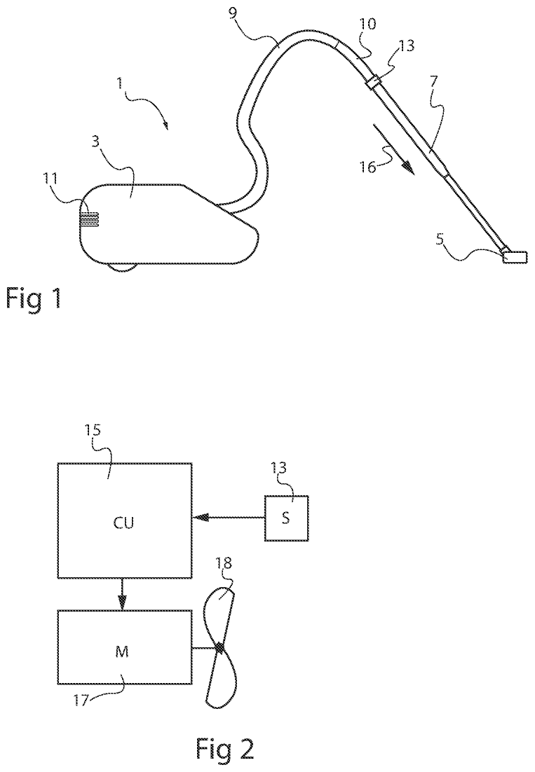

The present disclosure relates to a vacuum cleaner, for instance as illustrated in FIG. 1. This vacuum cleaner 1 comprises a main housing 3 comprising a motor, a fan and a dust separation device hidden therein. The motor is driven by a battery or by a connection via a cord to a mains socket. The motor is connected to the fan which provides a strong air flow from a nozzle 5 via a tube arrangement 7, 9 through the dust separation device in the housing 3 and to the ambient space through an air outlet 11 in the housing 3. In general, a dust separation device is used, which may be a dust bag, a filter, a cyclone, or a combination thereof.

In the illustrated case, the housing 3 is configured to be moveable on the floor by rolling, while the user maneuvers the tube arrangement. The tube arrangement comprises a flexible tube part 9 leading from the housing 3 on the floor to a rigid tube 7, leading to the nozzle 5, which often rests on the floor for floor cleaning.

The present disclosure is however equally useful in an upright- or stick-type vacuum cleaner 1′ such as illustrated in FIG. 6, only having a stiff tube 27 leading from the nozzle 5 to a handle 8 and where the housing 3 is fitted on this stiff tube. In both cases the user moves the nozzle around by pushing and pulling the rigid tube 7, 27 in different directions, sometimes also lifting the nozzle 5 from the floor.

The above-mentioned basic vacuum cleaner designs are well known as such. Recent initiatives such as regulations has sought to reduce the power used in a vacuum cleaner, for instance by limiting the maximum electric power used. By e.g. clever nozzle designs it has been possible to maintain or even improve the vacuum cleaner's dust removing efficiency despite lowered maximum motor power. This has partly been achieved by making the inner space in the nozzle greater, and by making the outer boundaries of the nozzle to provide a tighter seal between this inner space and the ambient room. While this works very smoothly in most cases, for instance on hard floors, some circumstances may lead to problems.

For instance, when vacuum cleaning a thick rug, the nozzle may in some cases become stuck on the rug and may be very difficult to move. A firm movement by the user in that case may even move the rug as a whole rather than cleaning the same.

This problem has been addressed to some extent U.S. Pat. No. 2,978,733-A shows one such example where an attempted movement of a rigid tube, in a case where the nozzle is difficult to move, opens a bypass opening that leaks air into the tube, possibly making the nozzle come loose from a rug or the like.

While such a solution helps temporarily, its use may be quite disturbing. As soon as the nozzle begins to move, the bypass opening is closed, meaning that the nozzle can again become stuck on the rug. The result may be a jumping motion of the nozzle if pushed or pulled over a rug. Also, the bypass opening produces a hissing sound that may be unpleasant.

The present disclosure seeks to accomplish an improved solution to this problem. This is done by providing a sensing device 13, which senses strain in the tube 7, 27 along the elongate direction 16 thereof. As illustrated in FIG. 2, instead of leaking air into the tube 7, a control arrangement 15 controls the output of the motor 17 in response to the sensed strain to change the pressure drop obtained with the fan 18.

This provides a more adaptable solution. For instance, if the sensor 13 provides a signal to the control unit 15 which indicates that the nozzle 5 is stuck, it is possible to lower the power output e.g. to 90% of normal power for a few seconds, e.g. 5-15 seconds as measured with a timer. If, during this period, it is again detected that the nozzle 5 becomes stuck again, it is possible for instance to lower the output power further, e.g. to 80% of normal power, and to reset the timer for a new lowered period. A number of different control schemes are possible to this end. It is even possible to make the vacuum cleaner adapt permanently to the area where it is used. For instance, it could know that the user's apartment has two rugs, one thick where a 75% output power is needed, and which is usually cleaned for about 45 second and a bigger but thinner one where a 90% output power is suitable, and which is cleaned for about 75 seconds. When sensing that the thick rug is cleaned, the control unit 15 may simply lower the motor's 17 output power to 75% for 45 seconds to provide a more effortless cleaning experience. Should the user desire to deep-clean a rug, for instance, the power-lowering function can be turned off.

In general, thus, this allows the vacuum cleaner to adapt to different floor surfaces. The control functions may be integrated with other control functions as software running on the control unit.

Other advantages with this arrangement is that the hissing sound of a bypass opening is eliminated and that even more energy is saved during the periods when the motor output power is lowered.

The sensing device 13 (cf. FIG. 1) may for instance be located in a vacuum cleaner tube end 10, which may be bent and form a handle part, e.g., the so-called bent end.

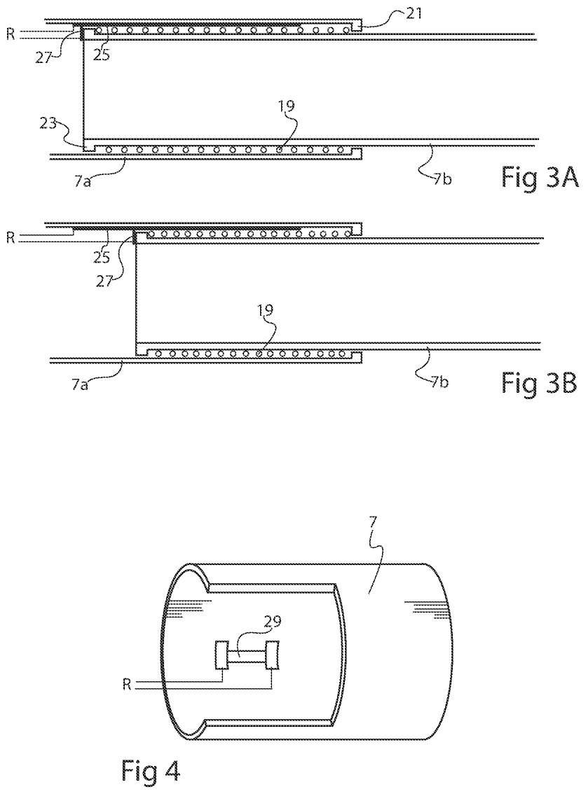

FIGS. 3a and 3b illustrate schematically a first example of a strain sensing arrangement. In this case, the sensing device is a spring-loaded rheostat.

By a rheostat is here meant a variable resistor. It may be implemented with two terminals of a linear potentiometer.

This may be done by providing a rigid tube (cf. 7 in FIG. 1) as two pieces 7a, 7b, where one 7b fits inside the other 7a, and is slidable therein in a telescopic manner. A spring 19 is fitted in between the two tube pieces 7a, 7b, and is trapped in this space by means of an outer circumferential ledge 23, at the end of the inner tube piece 7b, and a corresponding inner ledge 21 at the end of the outer tube piece 7a. By this configuration, the inner tube piece 7b can be slid towards the end of the outer tube piece 7a by compressing the spring 19, which requires the application of a strain in the elongate direction of the tube arrangement 7a, 7b.

This movement can be sensed by means of a rheostat arrangement 25, 27. In a basic configuration this can be made up from an insulated resistive layer 25 which is attached on the inside of the outer tube piece 7a, and a sliding connector 27 attached to the end of the inner tube piece 7b. When the tube 7a, 7b is subjected to a strong pulling strain, it is made longer by compressing the spring 19, and the sliding connector 27 slides along the resistive layer 25. This results in a resistance R between the end of the resistive layer 25 and the sliding connector 27 increasing, which can be detected by the control unit. Needless to say, the skilled person can obtain a rheostat arrangement providing a similar function in different ways, for instance detecting instead a pushing of the tube arrangement 7a, 7b.

FIG. 4 illustrates a second example of a strain sensing arrangement. In this case, the sensing device is a strain gauge load cell 29 which is attached to the inner surface of a tube 7. Such a load cell is capable of sensing a very small deformation of the tube 7, and although the difference in resistance is much lower than in the preceding example, an advantage is that no moveable parts are needed. The strain gauge load cell could be located on the outside of the tube as well.

Other ways of obtaining a sensing device are of course possible, piezo-electric cells could be considered, for instance.

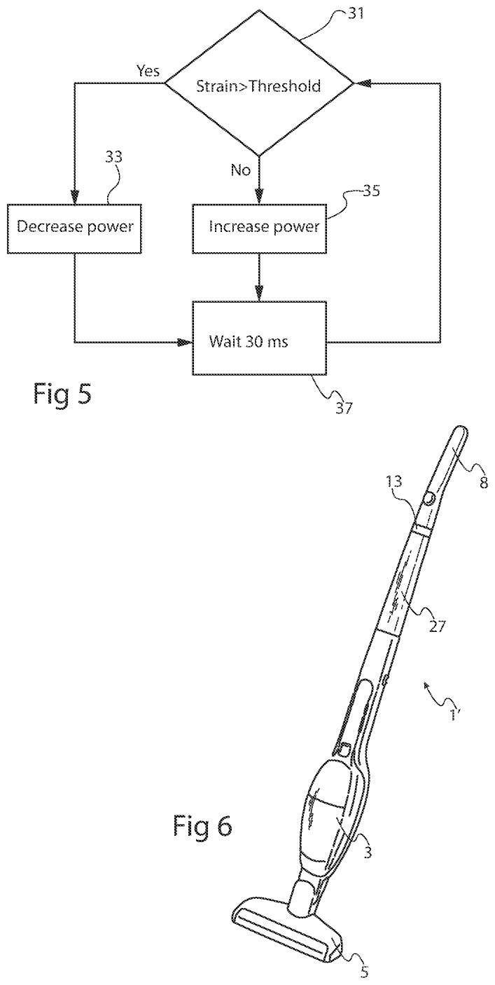

FIG. 5 illustrates a basic method for a control arrangement. It is tested 31 whether a strain in a tube part exceeds a predetermined threshold. If this is the case, the motor power can be decreased 33 to some extent, and if not, the motor power can instead be increased 35, unless the motor does not already run at full power. The process may then wait 37 a predetermined period of time, e.g., as illustrated 30 milliseconds, and subsequently repeat the test 31, perhaps lowering the power further. As mentioned this process can be made much more complex if desired. For instance, the threshold could be adaptable.

A simpler function may also be provided where the motor output is lowered during a period of time once high strain is detected, and then returns to normal output power. The length of this period of time may be adjusted depending on strain detection to obtain smooth operation. It is also possible to make the control unit vary the motor output as a function of the sensed strain. The control arrangement may also be affected by a user setting, e.g., allowing a higher power should the user temporarily need a high power to clean a very dusty rug allowing the nozzle to become stuck, for instance. The user may also change the force threshold, or switch the power reduction function off, for instance if deep-cleaning of a rug is desired.

The present disclosure is not restricted to the above-described embodiment and may be varied and altered in different ways within the scope of the appended claims.

1. A vacuum cleaner comprising:
a fan;
a nozzle;
a tube;
a dust separation device;
a motor configured to drive the fan to generate a suction flow from the nozzle via the tube, to the dust separation device;
a handle configured to control movement of the nozzle on a surface to be cleaned;
a sensing device configured to measure a force along a direction between the handle and the nozzl; and
a controller configured to control an output of the motor in response to the measured force.

2. The vacuum cleaner according to claim 1, wherein the sensing device comprises a variable resistor.

3. The vacuum cleaner according to claim 2, wherein the variable resistor comprises first and second parts, which are slideable in relation to each other in said direction against the force of a spring thereby changing the resistance of the variable resistor.

4. The vacuum cleaner according to claim 1, wherein the sensing device is a strain gauge load cell.

5. The vacuum cleaner according to claim 4, wherein the load cell is located in said tube.

6. The vacuum cleaner according to claim 1, wherein the controller is configured to lower the motor output if the sensed force exceeds a predetermined threshold.

7. The vacuum cleaner according to claim 6, wherein the motor output is lowered during a period of time.

8. The vacuum cleaner according to claim 1, wherein the controller is configured to vary the motor output as a function of a magnitude of the sensed force.

9. The vacuum cleaner according to claim 1, wherein the handle comprises a bent portion of the tube, and the sensing device is located in the bent portion of the tube.

10. The vacuum cleaner according to claim 1, wherein the controller is configured to receive a user setting.

11. The vacuum cleaner according to claim 10, wherein the user setting includes turning an output-lowering function off.

12. The vacuum cleaner according to claim 10, wherein the controller is configured to lower the motor output if the sensed force exceeds a predetermined threshold, and the user setting includes a setting of said threshold.

13. The vacuum cleaner according to claim 1, comprising a housing configured to be moveable on a floor and containing the motor and the fan and the dust separation device; and wherein:
the tube comprises a flexible tube and a rigid tube extending from a first end to a second end, with the flexible tube connecting the housing to the first end of the rigid tube;
the handle is provided at the first end of the rigid tube; and
the nozzle is provided at the second end of the rigid tube.

14. The vacuum cleaner according to claim 1, wherein the vacuum cleaner is an upright- or stick-type vacuum cleaner.

15. The vacuum cleaner according to claim 1, wherein the dust separation device is a dust bag, a filter, a cyclone, or a combination thereof.

16. A method for operating a vacuum cleaner comprising a fan driven by a motor, the fan being configured to generate a suction flow from a vacuum cleaner nozzle via a tube, to a dust separation device, the vacuum cleaner comprising a handle, the method comprising:
measuring a force along a direction between the handle and the nozzle, and
controlling an output of the motor in response to the measured force.

17. The method according to claim 16, wherein controlling the output of the motor comprises lowering the motor output during a predetermined time upon determining that the force exceeds a predetermined threshold value.
